(19) United States
(12) Patent Application Publication
(10) Pub. No.: US 2013/0285340 A1
(43) Pub. Date: Oct. 31, 2013

(54) SHOPPING BASKET

(71) Applicants: Elena ESTEBAN GUALLAR, Zaragoza (ES); Maria Isabel GIMENO VERDEJO, Zaragoza (ES); Javier LAYUS TORIJANO, Zaragoza (ES); Blanca SAVIRON CORNUDELLA, Zaragoza (ES)

(72) Inventors: Elena ESTEBAN GUALLAR, Zaragoza (ES); Maria Isabel GIMENO VERDEJO, Zaragoza (ES); Javier LAYUS TORIJANO, Zaragoza (ES); Blanca SAVIRON CORNUDELLA, Zaragoza (ES)

(21) Appl. No.: 13/870,538

(22) Filed: Apr. 25, 2013

(30) Foreign Application Priority Data
Apr. 26, 2012 (ES) P201230624

(51) Int. Cl. B62B 1/20

(52) U.S. Cl. CPC B62B 1/202
USPC 280/47.19

(57) ABSTRACT

The present invention disclosure relates to a shopping basket intended for being coupled on a larger second shopping basket of the type having wheels and steered by means of a pulling handle, and basically comprising a one-piece body with a front wall, a rear wall, two side walls and a bottom, and anchoring means intended for securing it on the lower basket, preventing it from tipping over.

### OBJECT OF THE INVENTION

The present invention generally relates to the field of shopping baskets commonly used in supermarkets and self-service shops. More specifically, the invention relates to a shopping basket complementary to larger baskets of the type having wheels and steered by means of a pulling handle.

### BACKGROUND OF THE INVENTION

A wide variety of systems for aiding in transporting items purchased in supermarkets and the like, ranging from small baskets which are carried manually by users to carts providing a large transport capacity for purchasing a large number of items or for very bulky items, are currently known. However, these two options have drawbacks.

In the first case, these drawbacks arise when the number, weight or volume of items to be carried is such that it is either uncomfortable for the user to transport the basket or because the basket is insufficient for transporting the items.

In the second case, carts may not be adequate if for example the items which will be acquired do not require such a large volume or in establishments in which the circulation of carts is complicated. The number of such carts further tends to be limited due to cost problems, so often there are no available carts when the user enters to start shopping.

Therefore, in the last few years increasingly more alternative types of shopping basket have been developed. For example, medium sized pulling baskets comprising wheels in their lower part and a telescopic or extendible handle for being adapted to the height of the user such that the user can easily and comfortably steer it either parallel or inclined with respect to the ground, already exist on the market. Examples of such baskets are disclosed in patents ES 2270676 and ES 2288138 from the same applicant.

Nevertheless, on occasions these baskets also suffer from certain drawbacks, such as the fact that the cubicle of the basket is not large enough and/or its design does not allow withstanding large weights if the basket is overloaded with an excess of items, which forces carrying the surplus items by hand or else resorting to another basket of the type which must be carried manually by the users, with the evident inconvenience which carrying it in one hand while shopping and simultaneously dragging the pulling basket with the other entails. In some cases, the user even places one basket on top of another for the purpose of transporting them simultaneously, turning them into a completely unstable and even dangerous set because of the impacts that may occur or because of the risk that the basket located on top can fall, spilling its content.

On the other hand, the items must be stacked on top of one another due to the vertical design of these baskets, running the risk of crushing and damaging the more delicate items under the weight of the rest of the products. Furthermore, when retrieving the items at check-out, it is uncomfortable for the user to have to bend down to the bottom of the basket, practically at ground level, to pull all the items out. This drawback is further increased in the case of the elderly or people with reduced mobility.

For the purpose of overcoming these drawbacks, there are also some systems based on a supporting structure or frame accommodating two or more baskets separated from one another on the market as in the case of US2009058025. However, said structures have the drawback that the mentioned supporting structure is quite bulky, which entails a serious storage problem for commercial surface areas having a large number of these devices, where even though the baskets can be stacked on top of one another, the mentioned carrying elements take up a large space.

Therefore, there is a need in the state of the art to have a system which allows, on one hand, dividing up the load for the purpose of separating the delicate items either by their structure or by their nature (for example separating cleaning products from foods), and on the other hand, providing the user additional storage space which can be transported comfortably without needing to be transported separately. In turn, it is necessary for the system solving these problems to be a system allowing its storage in the smallest volume possible.

### DESCRIPTION OF THE INVENTION

The present invention solves the aforementioned drawbacks disclosing a shopping basket intended for being coupled on top on a usually larger second shopping basket, such as the shopping baskets of the prior art described hereinabove.

Specifically, the shopping basket of the invention provides the user the possibility of increasing the volume of purchased products without needing to resort to a conventional cart as a result of comprising anchoring means for anchoring to a lower basket, of the type having wheels and steered by means of a pulling handle, thus allowing combining the storage space of two different shopping baskets, which entails not only a larger storage volume or capacity but having a compartmentalization for comfortably separating the acquired items depending on factors such as fragility, hygiene, weight, volume, etc.

These anchoring means which the basket of the invention comprises are such that they prevent the basket from tipping over when it is placed on the lower basket with wheels, thus allowing them both to be transported together. More specifically, said anchoring means are such that they are intended for fixing or securing the basket of the invention to the pulling handle of the basket on which it will be located. Nevertheless, to improve the securing between both baskets, the basket of the invention could further have additional securing means.

Evidently, if the securing of the basket of the invention located on the lower basket with wheels is not assured, its usefulness would be reduced since it could cause accidents and/or the products inside it to fall. In contrast, it is of interest that the securing is reliable and allows continuing handling the conventional pulling basket with wheels when the basket of the invention is coupled, not only in the standby position, but especially when said basket with wheels is moving, which is generally done inclined with respect to the ground.

Furthermore, the configuration of the basket of the invention is such that it allows that when coupled to most baskets with wheels steered by means of a pulling handle, the entry or exit of the items in said lower basket is not prevented, whereby the user will be able to couple said baskets from the start and transport them as a single basket without it preventing either basket from being used as a storage space. In other words, placing the basket of the invention on the larger lower basket will not force removing it each time an item is to be introduced in or removed from said lower basket, being able to remain coupled until the time, even during, the placing of the items at the check-out or payment counter.

This is achieved as a result of its rectangular parallelepiped-shaped design the larger side walls or faces of which are considerably longer than the smaller side walls or faces. This shape means that when placed on top of the larger basket with wheels located in the lower part, they leave a free space in the opening of said lower basket, which tends to have a large quadrangular opening for creating the largest possible vertical volume.

Where appropriate, the shopping basket of the invention could be coupled on top of the type of basket having wheels and steered by means of a pulling handle even without placing items in said lower basket, but only in the basket of the invention, located on top, for the sole purpose of transporting it comfortably as a result of the wheels of the lower basket and subsequently facilitating taking the products out when arriving at the check-out or payment counter, which would be particularly advantageous for the elderly or people with reduced mobility.

On the other hand, the shopping basket of the invention is stackable, i.e., it allows inserting one basket inside another in its non-operative phase, such that it has a certain inclination of its side walls with respect to the vertical, such that the upper opening of the basket body is larger than the bottom.

### DESCRIPTION OF THE DRAWINGS

To complement the description that is being made and for the purpose of aiding to better understand the features of the invention according to a preferred practical embodiment thereof, a set of drawings is attached as an integral part of said description in which the following has been depicted with an illustrative and non-limiting character:

FIG. 1 shows a front perspective view of a shopping basket according to the preferred embodiment of the present invention.

FIG. 2 shows a rear perspective view of the shopping basket of FIG. 1 coupled on a larger shopping basket.

FIG. 3 shows an upper plan view of the shopping baskets shown in FIG. 2.

FIG. 4 shows a perspective view of the shopping baskets shown in FIG. 2.

FIG. 5 shows a cross-section view of two shopping baskets according to the preferred embodiment of the present invention, one fitted inside the other.

### PREFERRED EMBODIMENT OF THE INVENTION

As can be seen in the drawings and according to a possible practical embodiment of the invention, the basket of the present invention comprises a one-piece body defining a front wall (10), a rear wall (12), two side walls (14) and a bottom (16), as well as a collapsible handle (18) on its upper frame, such that it can also be used independently as a conventional shopping basket, being manually transported by the user.

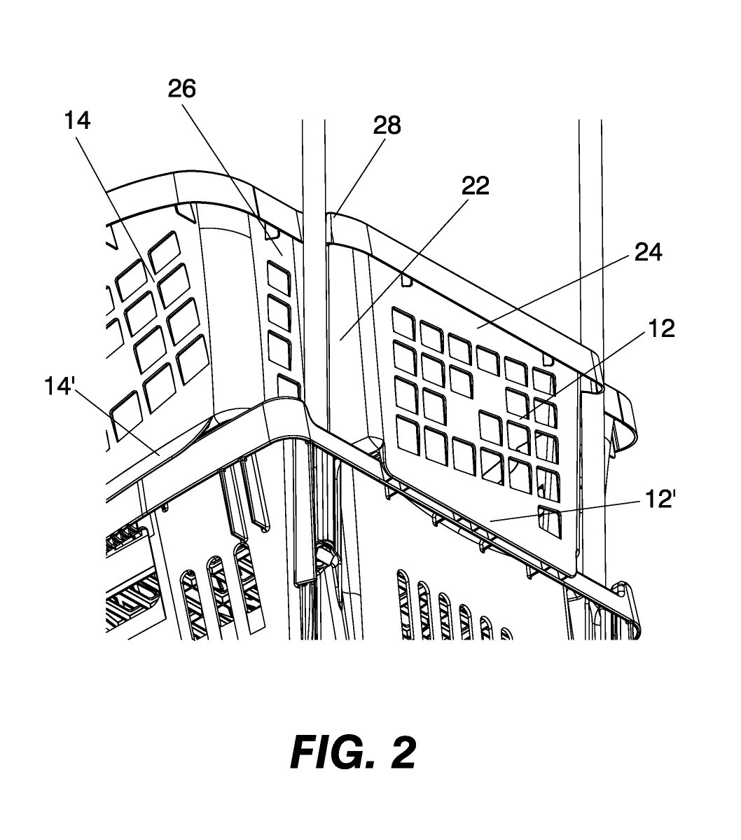

As described above, in addition to this already known structure the basket of the invention has anchoring means intended for preventing it from tipping over when it is located on a larger basket of the type having wheels and a pulling handle, which anchoring means specifically, and as can be seen in FIGS. 2, 3 and 4, are designed for being fixed to said pulling handle.

According to one embodiment which can be seen in the mentioned FIGS. 2, 3 and 4, the handle of the pulling basket can be of the “U-shaped” type, i.e., with two vertical parallel branches and one horizontal branch joining them at the top, in which case the rear wall (12) of the shopping basket of the present invention comprises a step (22) defining a central area (24) protruding from the basket body towards the rear part thereof as well as two side areas (26) which are inserted further towards the inner volume of the basket body.

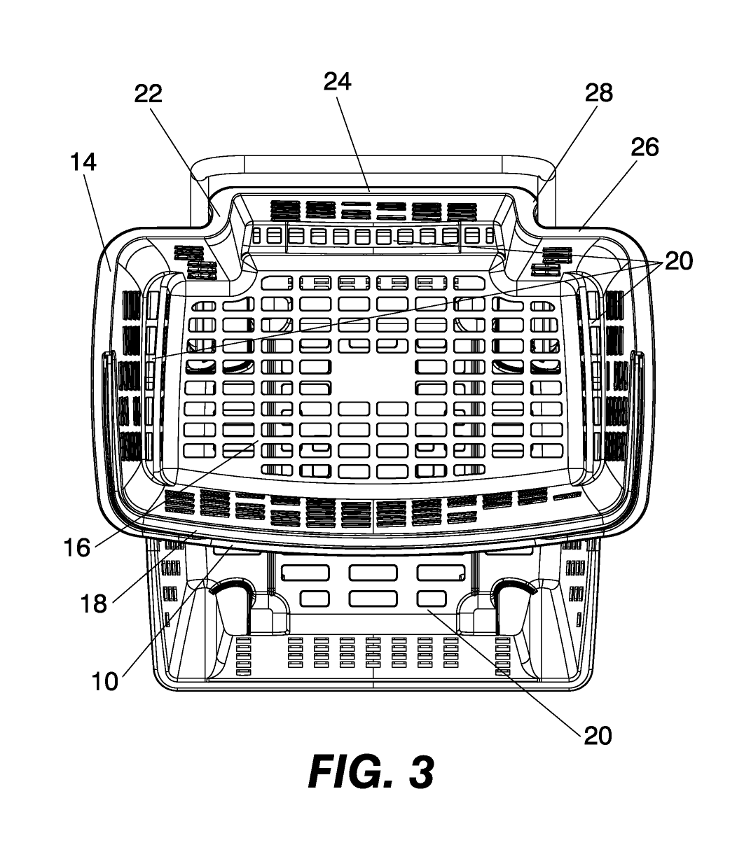

More specifically, FIGS. 2 and 3 show that said central area (24) is intended for being inserted inside a gap defined by the inside of an extractable handle of the larger second shopping basket when said handle is extended.

It can also be seen in said figures that elongations (28) protrude, in a lateral elongation of the rear wall (12), from the upper part of the central area (24) of said rear wall (12). Said elongations (28) are intended for performing a clamping function or for being anchored with the extractable handle of the larger second shopping basket, such that each vertical rod of said extractable handle is securely housed between a side area (26) of the rear wall (12), an area of attachment between said side area (26) and the central area (24) of said rear wall (12), and the corresponding elongation (28) of said central area (24).

According to another preferred embodiment of the present invention which is not depicted, instead of the elongations (28) protruding from the central area (24) of the rear wall (12) for anchoring to an extractable handle being located in only the upper part of said central area (12), they protrude from the entire height of said central area (12), or from a different part along the height of said central area (12), or even according to another possible embodiment, said elongations (28) could protrude directly from the rear wall (12), without there needing to be a central area (24).

Likewise, according to another embodiment of the present invention, the shopping basket comprises different anchoring means for anchoring to the extractable handle, such as for example a flexible clamp (defining a substantially C-shaped cross-section) or any other fixing or clamping element designed for gripping and anchoring each of the rods of said extractable handle.

Additionally, according to another possible embodiment and to further improve the securing, the basket of the invention could further have additional securing means as can be seen in the drawings. It can specifically be seen in FIG. 2 that the shopping basket comprises at least one projection (12′, 14′) protruding from the lower part of the rear wall (12) and/or the side walls (14), respectively. Said projections (12′, 14′) elongate its respective walls (12, 14) such that they are arranged on the outside of the corresponding walls of the larger second shopping basket on which the bottom (16) of the shopping basket of the present invention rests. A secure outside adjustment is thereby provided for keeping the shopping basket stably resting on the larger second shopping basket.

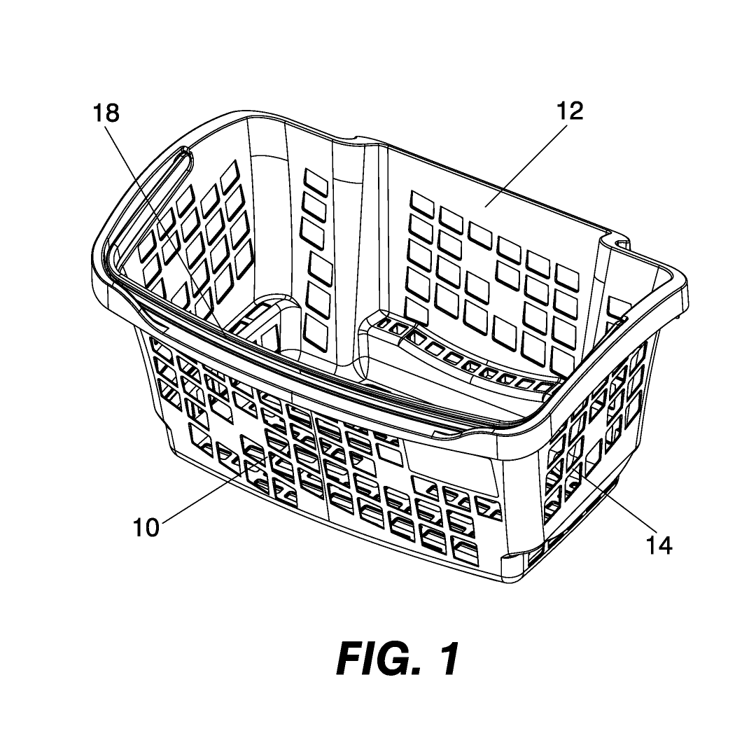

Furthermore, as seen in FIGS. 1, 3 and 5, the additional securing means can also comprise an inner step (20) in the bottom (16) of the basket, and more specifically in the attachment between the bottom (16) and the side walls (14), as well as between the bottom (16) and a central area (24) of the rear wall (12), which step defines a sort of perimetric step located in the bottom of the basket of the invention.

As can be seen in said Figures, the upper part of the inner step (20) is intended for resting on the upper edge of the side and rear walls of the larger second shopping basket. A vertical section of said inner step (20) is thus arranged inside the larger second shopping basket, parallel to its respective side and rear walls; while the bottom (16) of the basket body is inserted inside the space defined by the larger second shopping basket located in the lower part.

As a result of said inner step (20) which allows arranging a lower part of the basket body inside the larger second shopping basket together with the projections (12′, 14′) described above, an even more secure fixing is provided between both baskets such that the combination thereof can be used as if it were a single shopping basket with two independent compartments.

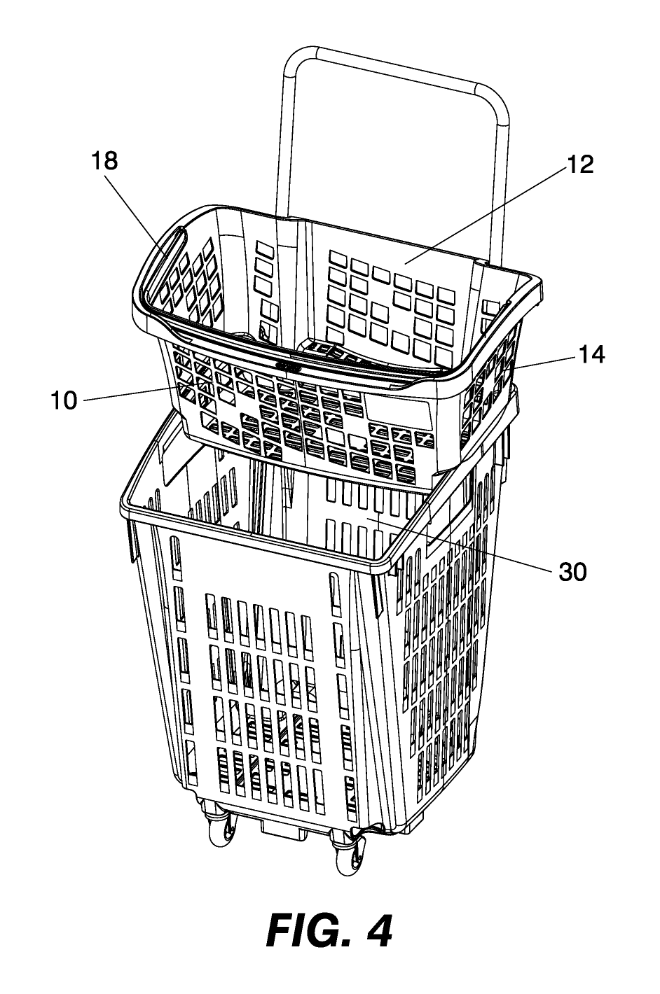

In reference to FIGS. 3 and 4, it can be observed that the bottom (16) of the basket body is intended for resting on the upper edge of the rear wall of the larger second shopping basket, as well as on only one section of the upper edge of the side walls of the basket (and not on the entire upper edge of said side walls).

Therefore when the basket body rests on the larger second shopping basket, it does not cover the entire, usually large, quadrangular-shaped upper opening of the latter, such that there is an access gap (30) sufficient for inserting or taking out items. This is achieved as a result of the design of the basket of the invention being rectangular parallelepiped-shaped, the larger side walls or faces of which are considerably longer than the smaller side walls or faces, according to a possible embodiment at least twice as long.

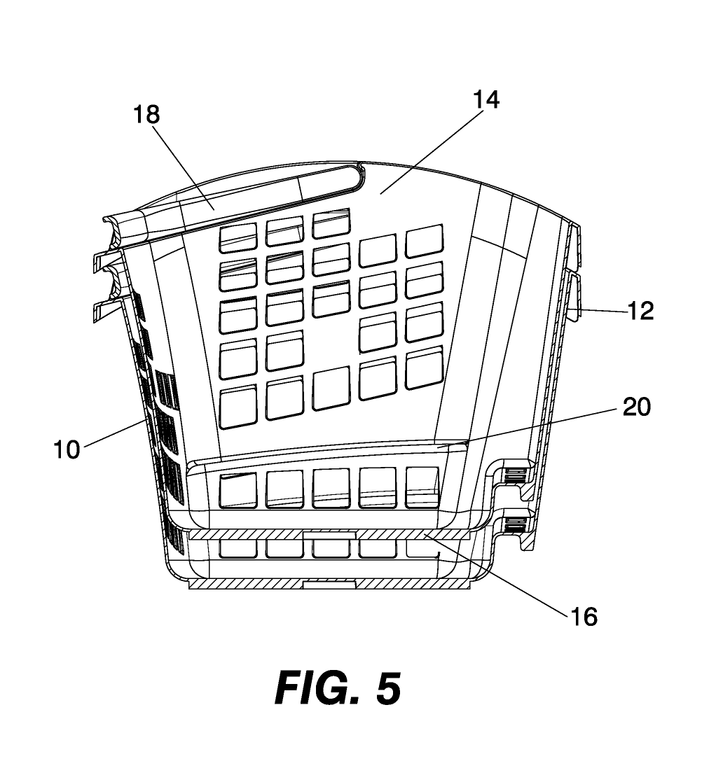

Lastly, and as can be seen in FIG. 5, the front wall (10), rear wall (12) and side walls (14) of the basket body of the invention have a determined inclination with respect to the vertical, such that the upper opening of the basket body is larger than the bottom (16) of the basket body. As a result of this inclination of the various walls (12, 14, 16), stacking or fitting one shopping basket inside another is allowed as shown in FIG. 5. This feature provides optimal storage of the shopping baskets when they are not being used, taking up the least space possible.

1. Shopping basket formed by a one-piece body with a front wall, a rear wall, two side walls and a bottom, comprising anchoring means intended for preventing it from tipping over when it is located on a lower basket of the type which moves by means of wheels.

2. Shopping basket according to claim 1, wherein the anchoring means are such that they allow the fixing to the pulling handle of the basket located in the lower part.

3. Shopping basket according to claim 2, wherein the anchoring means for anchoring to the pulling handle of the basket located in the lower part consist of elongations protruding from a central area defined by a step of the rear wall, wherein said central area protrudes from the body of the basket towards the rear part thereof for being inserted inside the gap defined by the vertical branches of the handle of the lower basket.

4. Shopping basket according to claim 2, wherein the anchoring means for anchoring to the pulling handle of the basket located in the lower part consist of elongations protruding from the rear wall.

5. Shopping basket according to claim 1, further comprising at least one projection protruding from the lower part of the rear wall and the side walls such that they are arranged on the outside of the corresponding walls of the lower basket on which the bottom rests.

6. Shopping basket according to claim 1, further comprising an inner step in the attachment between the bottom and the side walls and in the attachment between the bottom and a central area of the rear wall defining a perimetral step such that the upper part of said inner step rests on the upper edge of the side wall and rear wall of the lower basket at the same time as the bottom is inserted inside the space defined by said lower basket.

7. Shopping basket according to claim 1, wherein the front wall, rear wall and side walls of the basket body have an inclination with respect to the vertical, the upper opening of the basket body being larger than the bottom of the basket body, such that stacking one shopping basket inside another is allowed.

8. Shopping basket according to claim 1, further comprising a collapsible handle, such that the independent use of the shopping basket, without resting it on a larger second shopping basket, is facilitated.

9. Shopping basket according to claim 1, wherein the one-piece body is rectangular parallelepiped-shaped the larger side walls or faces of which are at least twice as long as the smaller side walls or faces.
